(19) United States
(12) Patent Application Publication
(10) Pub. No.: US 2009/0013208 A1
(43) Pub. Date: Jan. 8, 2009

(54) REAL TIME AUTOMATED EXCEPTION NOTIFICATION AND REPORTING SOLUTION

(76) Inventor: Thomas M. DiMuzio, Whitinsville, MA (US)

Correspondence Address: EMC CORPORATION;OFFICE OF THE GENERAL COUNSEL, 176 SOUTH STREET, HOPKINTON, MA, 01748, US

(21) Appl. No.: 12/058,847

(22) Filed: Mar. 31, 2008

(51) Int. Cl. G06F 11/07; G06F 7/06; G06F 17/30; G06F 9/46

(52) U.S. Cl. 714/2; 707/5; 714/57; 719/313; 714/E11.023; 714/E11.025; 707/E17.014

(57) ABSTRACT

A closed loop, autonomic exception notification and resolution system enables an application to proactively collect and forward exception information to developers with no user intervention; in some cases before the user is even aware that an exception has occurred. A notification process ensures that the appropriate resources can be applied to exception resolution, increasing error resolution by decreasing duplicate or misdirected efforts. An error coding scheme ensures that errors are uniquely and consistently reported while allowing duplicate issues to be grouped, further reducing duplicated efforts and improving resolution time. The use of an Exception Object which is automatically populated ensures that all information that is necessary to resolve the exception is provided to developers, thereby reducing debug time. Error resolutions are stored in a centralized database which can be accessed to quickly leverage previously generated solutions.

### FIELD OF THE INVENTION

This invention relates generally to the field of software and more particularly to a closed loop system and method for identifying, reporting, fixing and handling software exceptions.

### BACKGROUND OF THE INVENTION

Software applications are comprised of program code which operates on data to perform a particular task. The program code is written by software developers using a programming language such as C++, Java, XML, HTML or the like. Before an application is released by a developer for public use it is thoroughly tested using diagnostics to identify and correct exceptions, or ‘bugs,’ in the program code which may cause the application to behave in an unpredictable manner.

Although it is a goal to thoroughly test each application to identify and remove bugs, it is often difficult for a developer to anticipate every situation in which the application will be used. As a result, programs may encounter exception conditions following public release. When an exception condition is encountered, a software exception notification is triggered to notify the user that the application is not responding as anticipated. Continued use of the application may require the user to contact the developer to obtain a bug fix, patch, or new revision of the application.

Some software applications have a “call home” option built into the application. When an error occurs, the application will prompt the user to send error information back to the developers/company. This manual process generally requires user authorization before the error notification is sent to the developers and as a result issues may go unreported. The error information that is gathered by the “call-home” software is usually limited to the error and the operating system version. Information such as the origin of the exception and the operating environment that the application was running may not be available to the developer, making it difficult for the developer to accurately categorize, debug and remedy the errors.

Less sophisticated methods require the user to call the software developer, log into a website of the developer, e-mail the developer or otherwise contact the developer/company. Such methods rely on a user's ability to identify and gather pertinent information that would be useful for debugging software. Depending upon the sophistication of the user, the information provided by the user may be inaccurate, incomplete, inconsistent or simply not reported at all. The end result is often an unorganized influx of exception information that may or may not be accurate. For example, a user may be confused about which application caused the error, and therefore report errors that are unrelated to a particular application. Also, if a piece of software has one known bug that gets reported by ten different customers, that single bug could appear as ten unique, unrelated issues when reported.

A further problem with the current method of exception handling is that there is no guarantee that the user will contact the appropriate resource in the developer's company; rather, when exceptions are identified to the developer/company they may be funneled to different groups. For example when dealing with a software solution that may be part of a suite of utilities (such as Word is part of Microsoft Office), the different applications may be developed by different groups or teams of developers. Each group may have different error codes and different methods of tracking the errors. Exceptions that are entered manually by users may result in redundant efforts as multiple teams of developers try to fix the same problem and therefore delay error resolution.

An additional problem with the current method of exception handling involves providing feedback to the user. Typically the user/customer is not notified of any resolution unless the customer requests notification from the company/developer. Even if the user is notified, the notification may direct the user to download a patch or bug fix; the requirement of such manual intervention is frustrating for the user and prone to further error.

It would be desirable to identify a system and method which would overcome the problems associated with current exception handling methods.

### SUMMARY OF THE INVENTION

According to one aspect of the invention, a closed loop, automated exception notification system is provided that tracks, notifies and reports software issues in real time to the developers/support people while providing real time resolution and feedback information to the end users. Such a system provides an application self-repairing environment.

According to one aspect of the invention, a method for repairing an error in a software application operates responsive to the detection of an exception in an application executing for a user on a client device. Upon detection of the exception, an exception object is automatically populated with exception information. The exception object is forwarded to an exception notification service. The client device receives resolution information from the exception service for correcting the error and applies the resolution information to the application to remedy the error. The steps of automatically populating and forwarding are performed without intervention by the user, thereby facilitating accurate, real-time exception notification.

According to another aspect of the invention, a method of repairing an error in a software application includes the steps of receiving an exception object from a client device that executes the application, the exception object comprising: exception information uniquely associated with a client device, module information associated with the exception and an error description. Exception information may also include developer specific information. The exception object is automatically generated by the client without user intervention. The method includes the step of generating an error code using the module information and the error description, indexing an exception database using the error code to retrieve resolution information associated with the error and automatically forwarding the resolution information to the client device.

According to a further aspect of the invention, a system for application self-repair comprises a computer processor coupled to a storage device, the storage device comprising an application which is operable when executed upon by the computer processor to perform a task and a Dynamic Linked Library (DLL) stored in the storage device, the DLL comprising program code operable when executed upon by the computer processor, and in response to the detection of an error of the application performing the task, to automatically collect exception information associated with the error; and forward the exception information to an exception service.

According to another aspect of the invention, a system for application self-repair comprises an exception database storing at least one exception entry comprising an error code, exception information associated with an error and resolution information associated with the error. The system further includes a computer processor coupled to a storage device, the storage device comprising program code of an exception service which is operable when executed upon by the computer processor, and in response to the receipt of exception information associated with an application error from a client device executing an application, to generate an error code using at least a portion of the exception information, compare the generated error code against error codes stored in the database to locate resolution information for the application error, forward exception information to a user interface to enable a developer to resolve the application error, notify subscribing developers of the application error and forward resolution information to the client device.

### BRIEF DESCRIPTION OF THE DRAWINGS

FIG. 1 is a block diagram showing exemplary components of the automated software exception notification system of the present invention;

FIG. 2 illustrates exemplary fields of an exception database entry;

FIG. 3 is a functional flow diagram used to describe the closed loop exception notification and resolution process of the present invention;

FIGS. 4-6 illustrate an exemplary exception object viewer user interface and is used to discuss exception object attributes;

FIG. 7 illustrates an exception report that may be displayed on an exception viewer interface to display exception information; and

FIGS. 8-10 together illustrate an user interface for viewing an exemplary error report and are used to discuss how the interface may be used to resolve the error.

### DETAILED DESCRIPTION

The present invention comprises an automated exception notification system capable of tracking, notifying and reporting software issues in real time. The system includes a feedback loop which may be used to provide real time resolution, debug, or update information as well as links to training materials to clients.

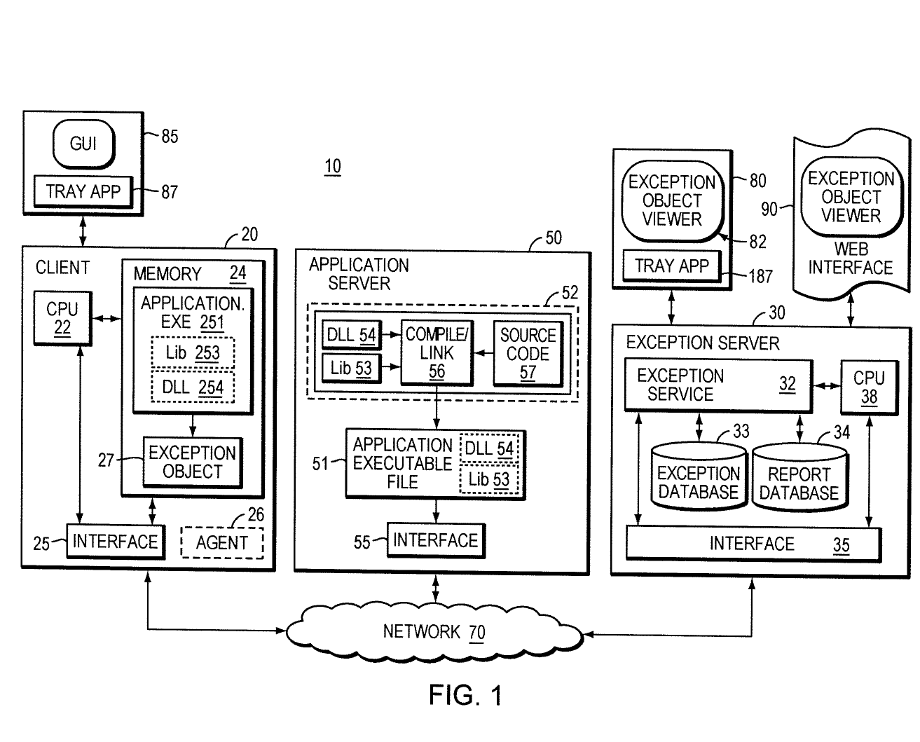

FIG. 1 illustrates several components that may be provided in a system of the present invention. Devices including an application server 50, client 20 and Exception Server 30 are each shown coupled via a network 70. Network 70 may be any type and combination of networks, including the Internet, and each of the devices include respective interfaces 25, 55 and 35 which enable the devices to communicate via the network 70. In general the application server is associated with a software developer, the client is a software consumer, and the Exception Server hosts a service of the present invention which facilitates application exception identification and resolution in real-time. Although in the below discussion the application server, client and Exception Server are shown and described as discrete devices, it should be appreciated that the service of the present invention may be executed at any device that has access to the network 70. Thus the services of the Exception Server may be supported by the application server, at the client, or at a third party device.

Application server 50 stores application source code 57 in a memory 52. The application source code 57 comprises program code written in a programming language to perform a particular application task. The application source code 57 is compiled by compiler 56 to provide a binary object file which may either include or be linked with libraries such as libraries 53 and 54 to together provide an executable file 51. The executable file, when executed by a processing device, performs the application task. According to one aspect of the invention, one of the libraries 54 is a Dynamic Linked Library (DLL) of the present invention. The DLL 54 comprises a suite of commands and routines that may be compiled with and used by any application, database, web page and/or other service to notify developers in real time of issues that may otherwise go unreported or under-reported. As will be described in more detail below, the DLL is used to generate an ‘Exception Object’ upon the detection of an exception during operation of the application. The Exception Object includes detailed exception information that may be used by an application developer to identify and repair application exception conditions in real time.

The executable file 51, comprising the compiled application and libraries 53, 54 is delivered to the client 20 in any one of a variety of manners. For example, an application may be downloaded from the application server 50 via the Internet (i.e., using network 70 and interfaces 25 and 55). Alternatively, the application executable file may be stored on a fixed media and delivered to the client for loading. The application may be a stand-alone application, or may comprise both client and server code which interact to perform a particular task. The local copy 251 of the application at client 20 represents the copy of the stand-alone or client application that is stored at the client site 20, and DLL 254 represents the client's copy of the DLL 54 for the application. The client 20 may have one or more associated users, each of which have a user interface 85. As will be described in more detail below, each user interface 85 may be augmented to include a tray application 87. The tray application 87 allows users to subscribe to software developer events according to their own preferences. Although a separate tray application is shown, it is appreciated that the user may also receive event notification via existing services such as email and the like. The software developer events include, for example, exception discoveries, module updates, etc.

As mentioned above, the DLL 54 is a dynamic linked library of commands and routines that may be used to generate an Exception Object 27 upon the detection of an exception by the client 20. The DLL in one embodiment is delivered pre-compiled to developers, and linked into applications by developers prior to delivery of the application to a client. The DLL is operable when executed upon by a processing device of the client (such as Central Processing Unit (CPU) to perform tasks associated with generating Exception Object 27. The tasks include, but are not limited to, extracting pertinent information from various data structures and registers of the application, serializing and de-serializing exception information, forwarding exception information to the Application Server 50 and providing feedback to the user. The DLL may comprise program code written in any programming language capable of generating a data structure or other object that may include information associated with an exception.

The Exception Object 27 of the present invention is automatically populated by the DLL in response to the detection of an exception at the client 20. The Exception Object 27 is an object based data structure which comprises a plurality of attributes that may be used by the Exception Server 30 to: identify the type of exception, identify the appropriate resources for resolving the exception and forwarding the resolution to the client. Exemplary field of the Exception Object include Exception Source information [including, for example, module identifier information (such as the name and version of the module which caused the exception) and client information (such as the client IP address and client name)] and Exception Error information (such as the time and date of the error associated with the exception, and a description the error).

The DLL may also selectively include additional, developer specific information in the Exception Object for each application. Such additional information includes, but is not limited to the following: a stack trace reflecting stack contents when the exception was triggered, the name of the application server, a process list (including thread count and handle count) of executing processes when the exception was triggered, the caller name (of the routine which called the excepting module), caller version (version of the routing that called the excepting module), creator name (i.e., of the software developer of the excepting module), file name (Assembly), method (Namespace.Class.Method), line number of the code where the exception occurred, any Attachments (List), an XML screenshot of the application upon exception, a Time Zone of the client, and Close status (indicating that the application was able to close the issue and recover).

Exception objects, once generated, are forwarded to the Exception server 30. In one embodiment, exception objects are forwarded immediately upon detection. In an alternate embodiment and agent 26 at the client 20 monitors an exception object repository at the client for new exception objects. The agent collects exception objects and periodically forwards one or more exception objects to the exception server as bandwidth becomes available.

The Exception Server 30 is shown to include an Exception Service 32, a central processing unit 38, an exception database 33 and a report database 34. The Exception Server 30 is also coupled to a user interface. The user interface 80 is an application programming interface, which may either be implemented using display code associated with an administrative console of the Exception Server 30, or alternatively may be implemented as a web-based interface which accesses the Exception Service via web pages. The present invention is not limited to any particular manner of presenting exception information to a developer/administrator.

The user interface is shown to include an Exception Object Viewer 82 and a Tray application 187. The Exception Object Viewer 82 allows developers that receive an Exception Object from a client to view the Exception Object and any file attachments that are included in the object. The tray application 187 is similar to the tray application 87 at the client 85, and allows a developer to subscribe for notification of one or more types errors related to one or more portions of application code. When using a web page interface, such as interface 90, notifications of errors may be provided via a similar mechanism as a system tray, for example by populating a portion of the web page to a list of errors, or links to Exception Objects.

In one embodiment, the structure of the Exception Object for each application may be defined using the Exception Object Viewer; for example, a developers interface may be provided that allows the developer to select the particular application information that would be most pertinent to the developer's determination of the origin and resolution of an error.

Thus when an error occurs, exception information is gathered and compiled into a single Exception Object file that contains pertinent information associated with the failing software. The Exception Object is used to generate a unique error code using the application name, version and error description as a seed, for example using a hashing algorithm or the like. The Error Code may be generated at the client or at the Exception server. The error code uniquely identifies each error that may occur.

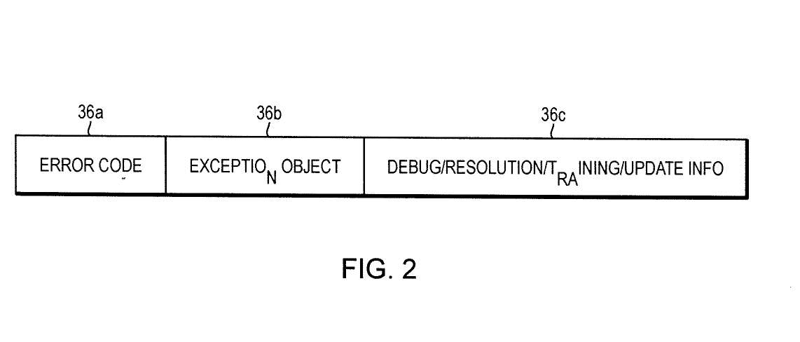

The Exception Database 33 stores all known error conditions and is indexed by the Error Code. Referring briefly to FIG. 2, an exemplary entry of the Exception Database 33 is shown to include an error code 36a, the Exception Object 36b and a Debug/Resolution object 36c. The Debug/Resolution Object 36 stores, for each error code, a determined resolution for the error. The resolution may include, for example, a ‘patch’ that may be downloaded to the client to remedy the error. As errors become ‘known’ and resolved, the Exception Database 33 is updated with the resolution. When an error code is received at the exception service 32 it is compared against all error codes stored in a central Exception Database 33. If the error code is found, the error condition can be quickly resolved using information in the Exception Database 33. If the error code is not found in the database, the new error code entry and the Exception Object will be saved to the server. A message will be returned to the user stating that the issue has been logged and a resolution is in progress. The message may include a link to where the user can find more information as it comes available and an optional ‘Subscription’ sign up (email notification) where the system can notify the user when the issue has been resolved. Once the new entry has been made into the database, a notification will be sent out (via web site interface, email or via the tray application) to all developers/support people that have ‘subscribed’ to receive exception notifications for that particular application.

The Reports Database 34 may be used to store information regarding application errors. The information may include a report of outstanding errors as well as statistics associated with the applications and errors, including frequency of error, time to resolution of error, etc. The reports may be accessed by the user interfaces 80, 90 to allow the developer to identify, resolve and track application errors. The developers may use either of the web interface 90 or user interface 80 to update application code to resolve an error. The Exception service feeds the resolution information back to the exception database, as well as forwards the resolution information to the appropriate clients via the network 70.

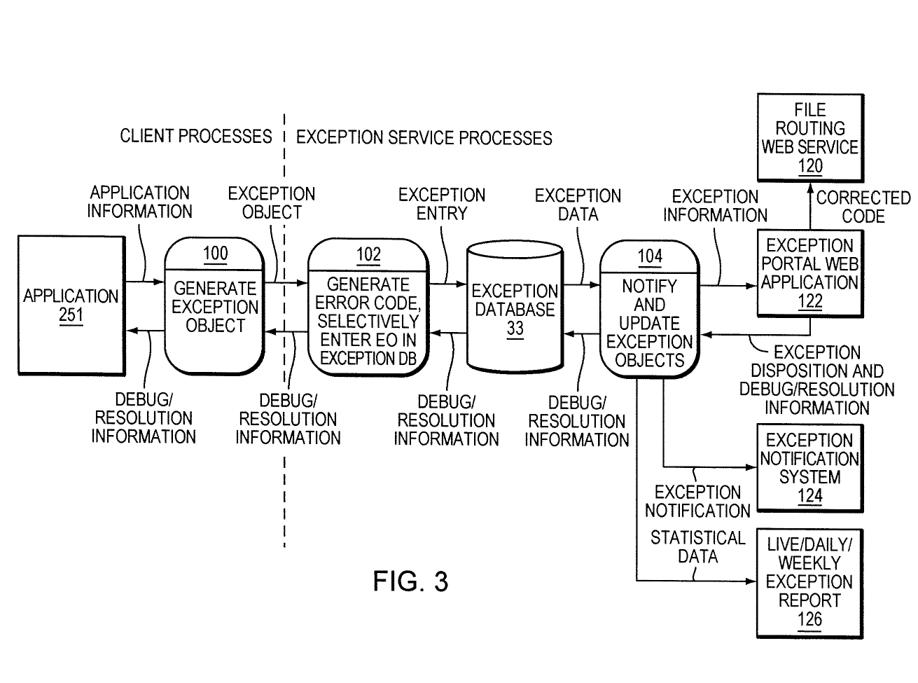

Accordingly the system 10 provides a closed loop, automated, autonomic architecture that facilitates real-time error reporting, identification, resolution and tracking to thereby provide a self-repairing application environment. FIG. 3 is a functional flow diagram, illustrating exemplary processes that may be performed by a client and an exception service during the closed-loop process of error self-repair, as well as data that may be exchanged between a client and an exception service.

An application 251 is compiled such that it links the Dynamic Linked Library (DLL) of the present invention. The DLL includes functionality for extracting pertinent information regarding a state of the application when an exception is triggered. As described above, the pertinent information includes module information (name, version, line number), as well as error information (description, time/date). As described above, the information may also include various state of the application when the exception is triggered, such as the contents of the stacks and registers, screen shots, etc. It is appreciated that each application is uniquely architected; thus, it is envisioned that the DLL may be personalized for each application to extract the most relevant information for each application. In addition, it is envisioned that the DLL may be a dynamic library that can be augmented from time to time to include functions for extracting additional information recognized to be of interest to the software developer.

When an exception occurs, exception information, identifying a type of the exception, is forwarded to the DLL process 100. Process 100 uses the functions provided by the DLL to extract application information for population of an Exception Object (EO) for the exception. The EO is then automatically forwarded to exception service processes, without any explicit action being performed by the user. Thus it can be seen that error reporting, in the present invention, occurs without any user intervention.

As described above, process 102 processes the EO to generate a unique error code to associate with the exception based select fields of the EO. In one embodiment the fields used to generate the error code include the module version number and the error description, although the present invention is not limited to the use of particular fields for generating the error code. It should be noted that although the error code generation process is shown performed by the exception service, it is envisioned that the DLL library forwarded to the client may be augmented to include error code generating functionality. Thus some of the ‘exception service’ processes may be split between the client and the Exception Server.

The error code is compared against the error codes stored in the exception database 33. If there is a match, and the exception entry includes a resolution to the error, the resolution can be forwarded back to the client. If there is no match, then the exception data is forwarded to a notification process 104. The notification process 104, in one embodiment, organizes the delivery of exception information to various systems, including an Exception Portal Web application 122, an Exception Notification System 124 and an Exception Report system 126.

The Exception Portal Web Application 124 provides a portal through which a software developer can gain access to the exception information, for example through the use of an Exception Object Viewer as described in FIG. 1. In one embodiment, the portal may be implemented as a web page. Various interfaces of the portal enable the developer to revise code to resolve errors. Corrected code can then be forwarded to a File Routing Service 120, to update the Application Server copy of the application, as well as back to the clients via the notification process 104.

The Exception Notification system 124, in one embodiment, controls the notification of exception information to subscribers. Thus, the Exception Notification System 124 may be used to notify the developers that additional Exception Objects have been placed in the portal, and it may be used to notify clients that the resolution of their error is progressing. It should be noted that it is not required that a client register with a subscription service to receive the resolution for the exception; in fact it may be said that the client device will receive unsolicited resolutions for exception conditions, some of which the particular users may be unaware.

In short, the notification system 124 interfaces with web pages, email and tray applications to ensure that notification information is sent to the appropriate subscribers.

The notify process 104 may also forward statistical information, associated with exceptions, to an Exception Report system 126. The Exception Report system is a customizable system which comprises a plurality of programmable filters that enable an administrator/developer to monitor the status of application related exceptions in a network.

### ILLUSTRATIVE EMBODIMENTS OF THE ASPECTS OF THE INVENTION

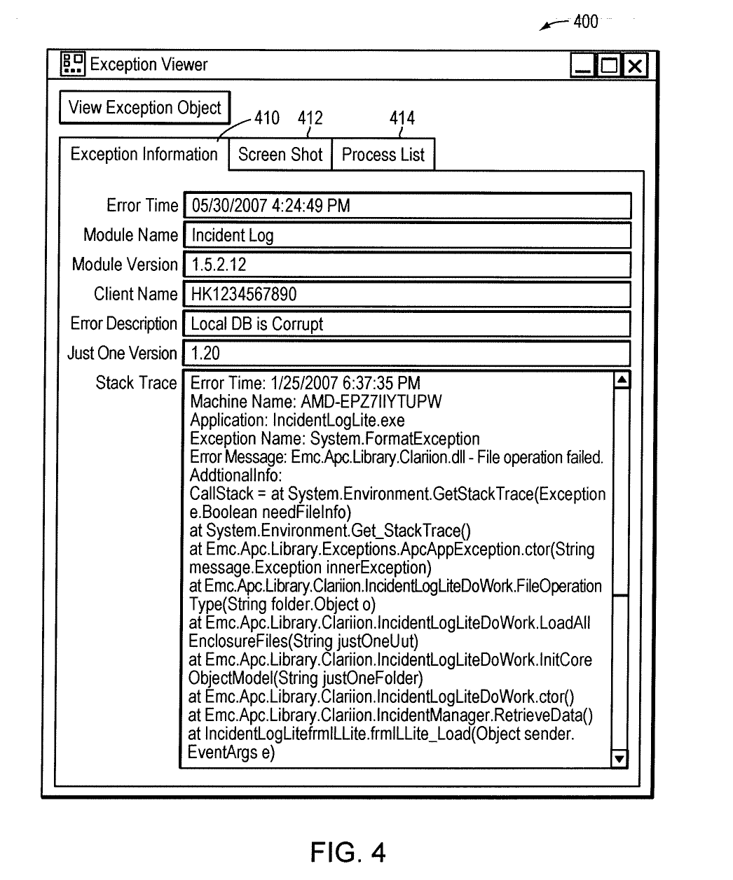

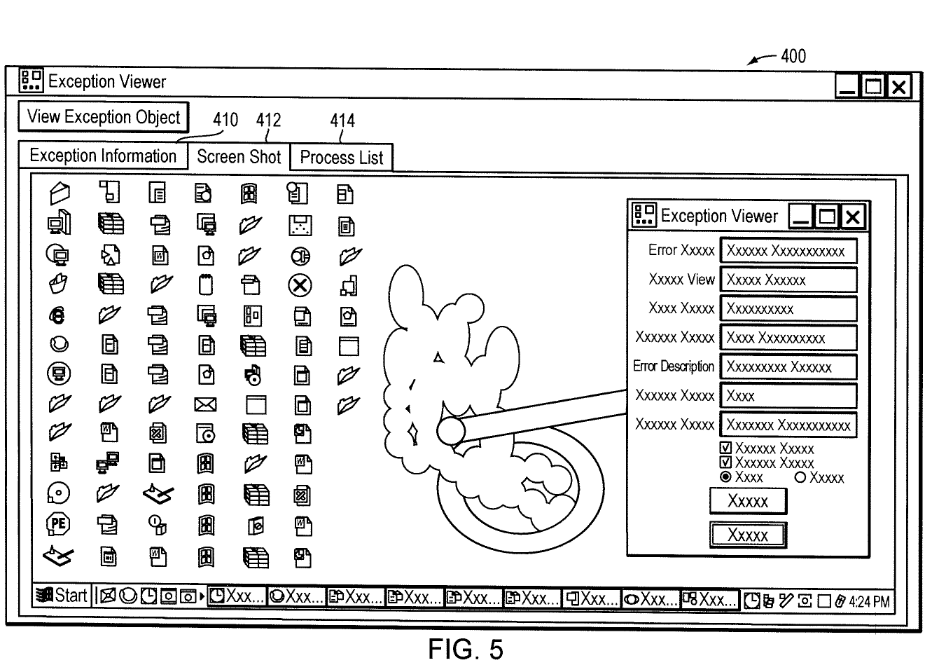

An illustrative embodiment of an Exception Object Viewer interface 400 is shown in FIG. 4. The Exception Object Viewer enables a developer to view all stored Exception Object attributes and data. In the example of FIG. 4 the Exception Object is presented using three tab-accessible windows, each window accessed by selecting an associated tab within the viewer 400. (Although windows are shown, an equivalent implementation would use a web page.) Exception Information can therefore be viewed by selecting the Exception Information tab 410 of the view 400. The Exception information includes several exemplary fields described above. FIG. 5 illustrates a screen shot window of the viewer, accessed by selection of the screen shot tab 412. The screen shot illustrates a view of the application window at the point of exception, and therefore may provide information to the developer regarding the operating state of the users' computer at the time of exception.

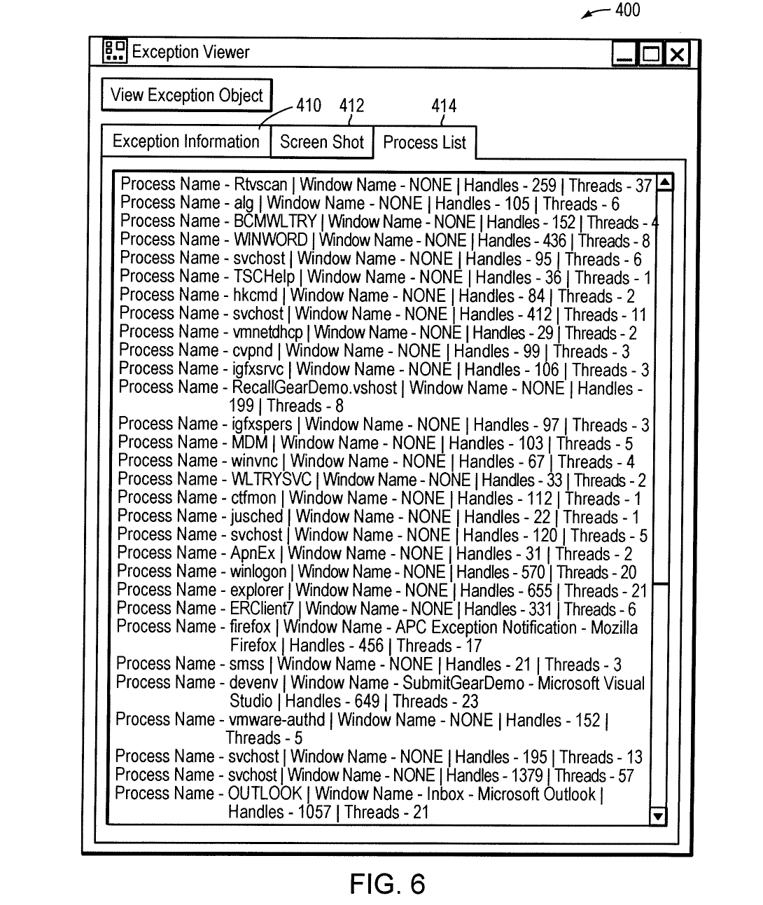

Further information regarding the operating state of the user's computer can be obtained by capturing a list of processes running at the time of exception, to facilitate the detection of interfering processes. In one embodiment, the Exception Object Viewer 400 includes a process list tab 414 which enables viewing of a process list window as shown in FIG. 6.

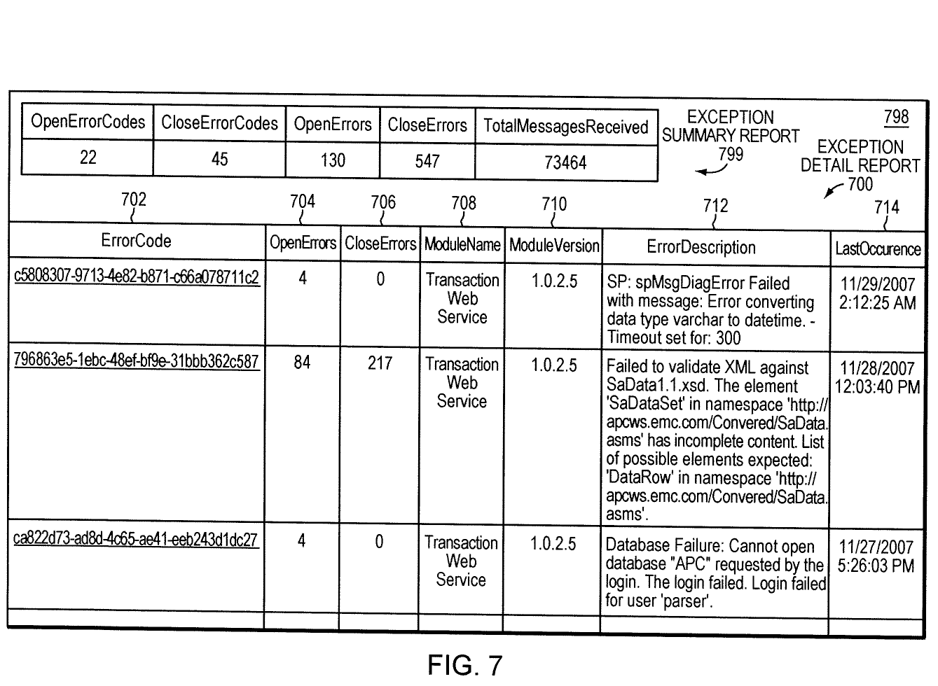

Referring now to FIG. 7, another embodiment of the Exception Notification system will now be described in the context of applications which are written as web services and comprised of XML code. The Exception Notification system provides a system for reporting errors for a suite of web services that process XML data messages. If a web service fails to process an XML message, the XML message is saved in the Exception Object along with any debug information helpful in resolving the issue. Saving unprocessed XML messages in this manner allows the client applications of the web services to continue on with their routine activity while the error causing code issue can be resolved. The Exception Notification system thus allows software developers to quickly resolve errors before a client may even know anything went wrong, while giving the developers insight into how they may prevent the issues from reoccurring, and ideas for enhancements or fixes they may want to add in future release versions of their software.

FIG. 7 shows an example Exception Report 798. The Exception Report 798 may be obtained through the use of pull down menus or other selection tools or buttons on the Web Service/User Interface. The Exception Report 798 is shown to include an Exception Summary Report 799 as well as Exception Detail Report 700. The Exception Summary Report 799 provides a summary of outstanding Exceptions for a given application. The Exception Detail Report 700 provides a variety of information for each Exception. An Error Code 702 uniquely identifies the Exception, and statistical information 702, 704 is provided for each exception. Module information 706, 708 identifies the source of the Exception, and the Error Description 710 and date of most recent occurrence 712 provides additional detail regarding the error.

There may be multiple unique occurrences of each error. Each time the error occurs, the count 704 of the report is incremented. Thus in the example of FIG. 7, the first Error Code has four open errors; that is four times the same type of failure occurred and has not yet been resolved. Errors can either have a status of Open or Closed. An Error Code is only Closed when all of its unique Errors have been Closed.

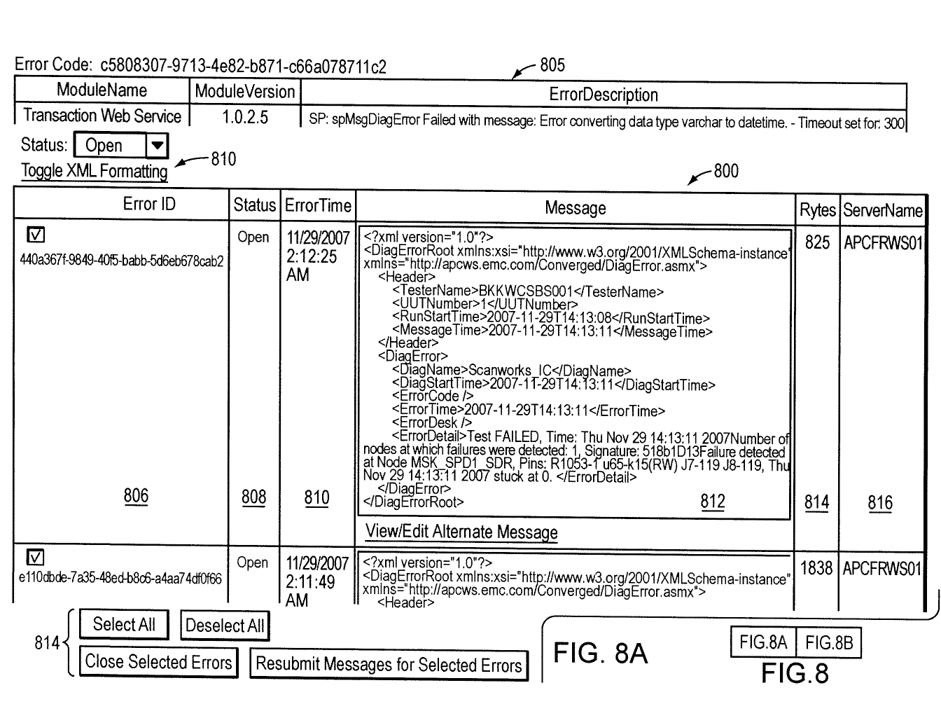

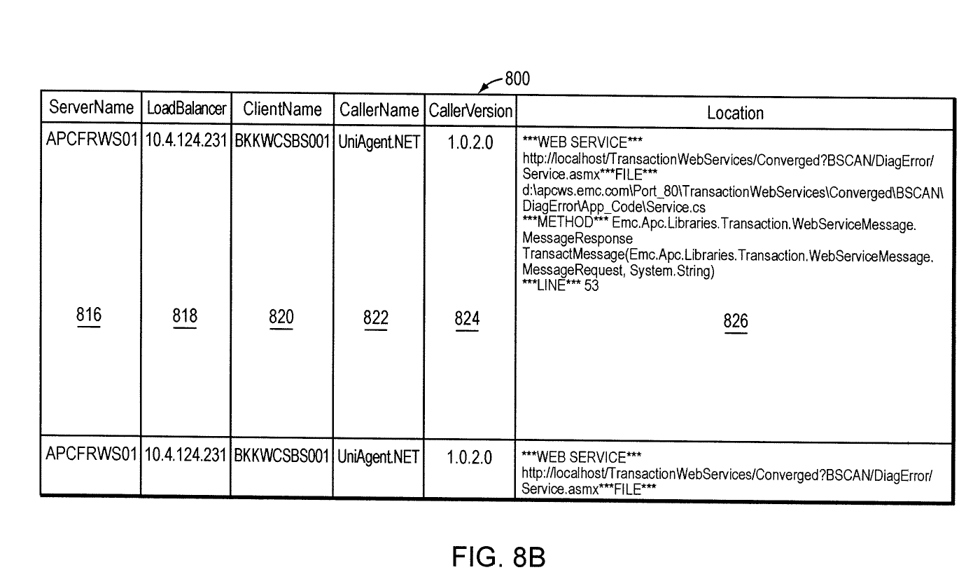

In one embodiment, the error code provides a hyper-text link to the associated Exception Object. To investigate an error, a developer can simply select the error code web link. FIGS. 8A and 8B together illustrate screen shots of a web based Exception Object Viewer interface that may be used to Exception Object information associated with the error code to enable the developer to resolve the issue.

In response to selection of the error code link, the window 800 is displayed, which lists all errors that have occurred and that are associated with the error code. The error code itself is presented in the portion 805 of the window. Buttons 814 can be used to control the selection, closing, and submission of messages associated with the individual errors listed in the window 800.

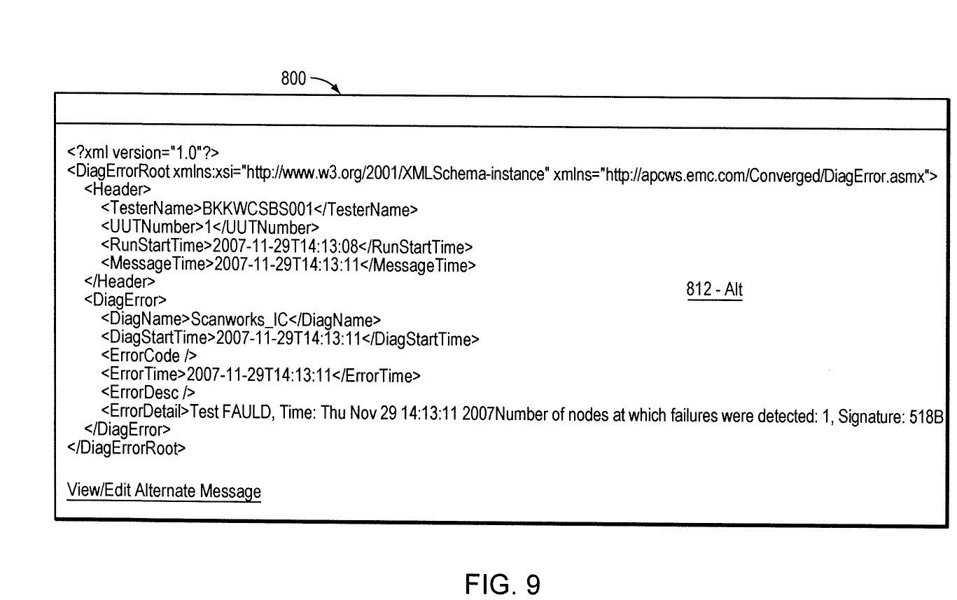

Each error has an associated Error ID which is unique to the client device that incurred the exception. Other information associated with the each error includes the status (open or closed) 808, time of the error 810, the message 812 that caused the error (viewable as text or in XML format) [FIG. 9 illustrates the text in XML format (812-Alt)], the number of bytes 814, of the message, the application web server name 816, an IP address of any intermediate device 818, the name of the client 820, the name of the application that caused the exception, the version of the caller 824 and the location of the line of code that caused the exception 826.

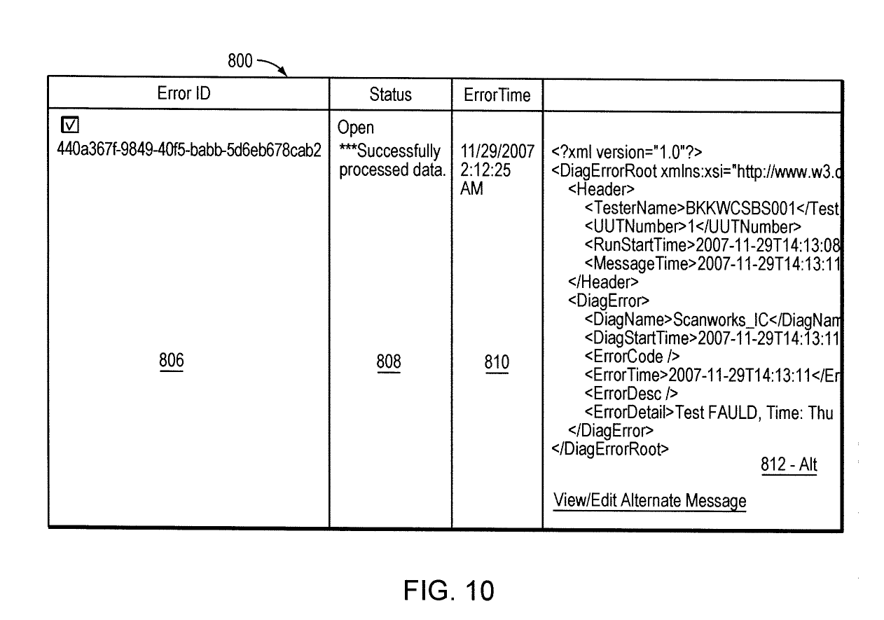

In one embodiment, the developer can edit the lines of code in windows 812/812-ALT and resubmit the XML message by selecting the box in field 806, and selecting the RESUBMIT button option (FIG. 8A). As shown in FIG. 10, should the edited text succeed, the status 808 field will indicate that the change has been successfully processed. In such an event, the error can be selected and the CLOSE button (FIG. 8A) can be used to close the error.

As described with regard to FIG. 3, the successful resolution of an error will result in the forwarding of the modified message back to the client, and the updating of the Exception Object in the Exception Database 33 to include the resolution.

It should be noted that the embodiment described with regards to FIGS. 4-10 are provided as illustrative only; it is envisioned that many different tools, services, windows and interfaces may be generated to display and use the information that is obtained by an exception object. Accordingly, the present invention is not limited to the disclosed embodiment.

Accordingly an automated Exception Notification solution has been shown and described which includes the ability to track, notify and report on software issues in real time. The system is a closed loop, autonomic system which enables an application to proactively collect and forward exception information to developers with no user intervention; in some cases before the user is even aware that an exception has occurred. A notification process ensures that the appropriate resources can be applied to exception resolution, increasing error resolution by decreasing duplicate or misdirected efforts. An error coding scheme ensures that errors are uniquely and consistently reported while allowing duplicate issues to be grouped, further reducing duplicated efforts and improving resolution time. The use of an Exception Object which is automatically populated ensures that all information that is necessary to resolve the exception is provided to developers, thereby reducing debug time. Error resolutions are stored in a centralized database which can be accessed to quickly leverage previously generated solutions.

Having described various embodiments of the invention, it will be appreciated that many of the above figures are flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem

The above description and figures have included various process steps and components that are illustrative of operations that are performed by the present invention. However, although certain components and steps have been described, it is understood that the descriptions are representative only, other functional delineations or additional steps and components can be added by one of skill in the art, and thus the present invention should not be limited to the specific embodiments disclosed. In addition it is understood that the various representational elements may be implemented in hardware, software running on a computer, or a combination thereof.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

1. A method for repairing an error in a software application executing on a client device for a user includes the steps of:
responsive to the detection of an exception in the application, automatically populating an exception object with exception information and forwarding the exception information to an exception notification service;
receiving resolution information from the exception service for correcting the error; and
applying the resolution information to the application to remedy the error, wherein the steps of populating and forwarding are performed without intervention by the user.

2. The method of claim 1, wherein the step of automatically populating the exception object uses a dynamic linked library personalized for the application to extract exception information from the application.

3. The method of claim 2 wherein the exception information is selected from a group including module information and error information.

4. The method of claim 3 wherein the exception information is selected from a group including a module version, a module name, an error description, an error time.

5. The method of claim 3 wherein the exception information further comprises at least one of a client device identifier, a screen shot, a stack trace, a process list, an application server identifier and an attachment file.

6. The method of claim 1, wherein the resolution information is unsolicited by the client device.

7. The method of claim 1 wherein the resolution information comprises at least one of a network location for downloading a patch, debug information, training information, and at least a portion of an updated application.

8. A method of repairing an error in an application includes the steps of:
receiving, from a client device executing the application for a user, an exception object comprising exception information associated with an error, the exception object including module information and error information, the exception object automatically generated by the client without user intervention;
generating an error code uniquely associated with the error using the module information and the error information;
indexing an exception database to retrieve resolution information associated with the error; and
forwarding the resolution information to the client device to enable the client device to repair the error.

9. The method of claim 8 further including the steps of:
in response to the step of indexing, determining whether resolution information exists in the database; and
responsive to the resolution information not existing in the database, forwarding the exception object to an exception object viewer interface and forwarding a notification of the exception object to a subscribing developer.

10. The method of claim 9 further including the step of forwarding a notification to the user regarding a pending resolution of the error.

11. The method of claim 8 further including the step of:
receiving resolution information for the error from the interface;
storing the resolution information in the database; and
forwarding at least one of the resolution information and a notification of the receipt of the resolution information to the client.

12. The method of claim 11 wherein the step of forwarding is unsolicited by the client.

13. The method of claim 8 wherein the resolution information comprises at least one of a network location for downloading a patch, debug information, training information, and at least a portion of an updated application.

14. A system for application self-repair comprises:
a computer processor coupled to a storage device, the storage device comprising an application which is operable when executed upon by the computer processor to perform a task; and
a Dynamic Linked Library (DLL) stored in the storage device, the DLL comprising program code operable when executed upon by the computer processor, and in response to the detection of an error of the application performing the task, to automatically:
collect exception information associated with the error; and
forward the exception information to an exception service.

15. A system for application self-repair comprises:
an exception database storing at least one exception entry comprising an error code, exception information associated with an error and resolution information associated with the error;
a computer processor coupled to a storage device, the storage device comprising program code of an exception service which is operable when executed upon by the computer processor, and in response to the receipt of exception information associated with an application error from a client device executing an application, to:
generate an error code using at least a portion of the exception information;
compare the generated error code against error codes stored in the database to locate resolution information for the application error;
forward exception information to a user interface to enable a developer to resolve the application error;
notify subscribing developers of the application error; and
forward resolution information to the client device.
